(19) United States
(12) Patent Application Publication
(10) Pub. No.: US 2014/0015931 A1
(43) Pub. Date: Jan. 16, 2014

(54) METHOD AND APPARATUS FOR PROCESSING VIRTUAL WORLD

(71) Applicant: Samsung Electronics Co., Ltd., Suwon-si (KR)

(72) Inventors: Seung Ju HAN, Seoul (KR); Min Su Ahn, Seoul (KR); Jae Joon Han, Seoul (KR); Do Kyoon Kim, Seongnam-si (KR); Yong Beom Lee, Seoul (KR)

(21) Appl. No.: 13/934,605

(22) Filed: Jul. 3, 2013

Related U.S. Application Data
(60) Provisional application No. 61/670,825, filed on Jul. 12, 2012.

(30) Foreign Application Priority Data
Feb. 19, 2013 (KR) 10-2013-0017404

(51) Int. Cl. H04N 13/02

(52) U.S. Cl. CPC H04N 13/02
USPC 348/46

(57) ABSTRACT

A virtual world processing apparatus and method are provided. Sensed information related to an image taken in a real world is transmitted to a virtual world using image sensor capability information, which is information on a capability of an image sensor.

### CROSS-REFERENCE TO RELATED APPLICATIONS

This application claims the benefit under 35 U.S.C. §119(e) of a U.S. Provisional Application No. 61/670,825, filed on Jul. 12, 2012, in the U.S. Patent and Trade Mark Office, and the benefit under 35 U.S.C. §119(a) of a Korean Patent Application No. 10-2013-0017404, filed on Feb. 19, 2013, in the Korean Intellectual Property Office, the entire disclosure of which is incorporated herein by reference.

### BACKGROUND

1. Field

One or more example embodiments of the following description relate to a virtual world processing apparatus and method, and more particularly, to an apparatus and method for applying detection information measured by an image sensor to a virtual world.

2. Description of the Related Art

Currently, interest in experience-type games has been increasing. Microsoft Corporation introduced PROJECT NATAL at the “E3 2009” Press Conference. PROJECT NATAL (now known as KINECT) may provide a user body motion capturing function, a face recognition function, and a voice recognition function by combining Microsoft's XBOX 360 game console with a separate sensor device including a depth/color camera and a microphone array, thereby enabling a user to interact with a virtual world without a dedicated controller. Also, Sony Corporation introduced WAND which is an experience-type game motion controller. The WAND enables interaction with a virtual world through input of a motion trajectory of a controller by applying, to the Sony PLAYSTATION 3 game console, a location/direction sensing technology obtained by combining a color camera, a marker, and an ultrasonic sensor.

The interaction between a real world and a virtual world operates in one of two directions. In one direction, data information obtained by a sensor in the real world may be reflected to the virtual world. In the other direction, data information obtained from the virtual world may be reflected to the real world using an actuator.

Accordingly, there is a desire to implement an improved apparatus and method for applying information sensed from a real world by an environmental sensor to a virtual world.

### SUMMARY

The foregoing and/or other aspects are achieved by providing a virtual world processing apparatus including a receiving unit to receive sensed information related to a taken image and sensor capability information related to capability of an image sensor, from the image sensor; a processing unit to generate control information for controlling an object of a virtual world, based on the sensed information and the sensor capability information; and a transmission unit to transmit the control information to the virtual world.

The foregoing and/or other aspects are achieved by providing a virtual world processing method including receiving sensed information related to a taken image and sensor capability information related to capability of an image sensor, from the image sensor; generating control information for controlling an object of a virtual world, based on the sensed information and the sensor capability information; and transmitting the control information to the virtual world.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates a virtual world processing system that controls data exchange between a real world and a virtual world, according to example embodiments;

FIG. 2 illustrates an augmented reality (AR) system according to example embodiments;

FIG. 3 illustrates a configuration of a virtual world processing apparatus according to example embodiments; and

FIG. 4 illustrates a virtual world processing method according to example embodiments.

### DETAILED DESCRIPTION

Reference will now be made in detail to example embodiments, examples of which are illustrated in the accompanying drawings, wherein like reference numerals refer to the like elements throughout.

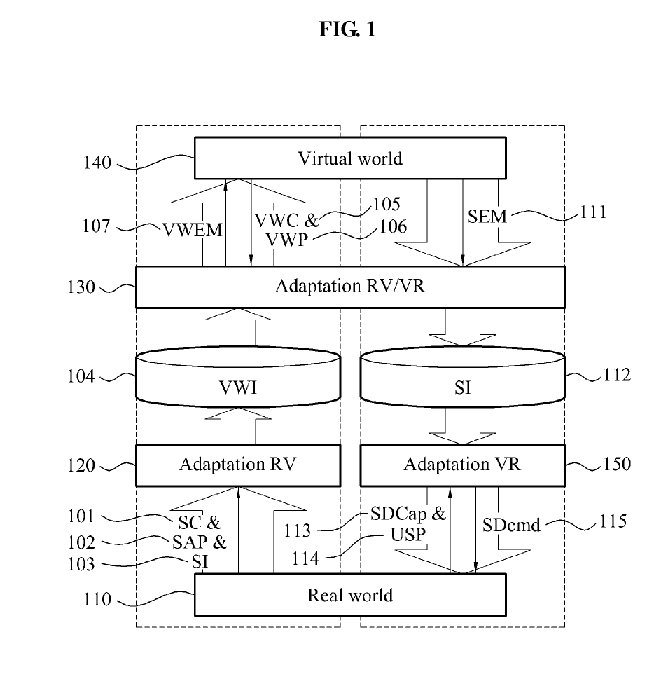

FIG. 1 illustrates a virtual world processing system that controls data exchange between a real world and a virtual world, according to example embodiments.

Referring to FIG. 1, the virtual world processing system may include a real world 110, a virtual world processing apparatus, and a virtual world 140.

The real world 110 may denote a sensor that detects information about the real world 110 or a sensory device that implements information about the virtual world 140 in the real world 110.

The virtual world 140 may denote the virtual world 140 itself, implemented by a program or a sensory media playing apparatus that plays contents including sensory effect information implementable in the real world 110.

A sensor according to example embodiments may sense information on a movement, state, intention, shape, and the like of a user in the real world 110 or of an environment of the user in the real world 110, and may transmit the information to the virtual world processing apparatus.

Depending on embodiments, the sensor may transmit sensor capability information 101, sensor adaptation preference 102, and sensed information 103 to the virtual world processing apparatus.

The sensor capability information 101 may denote information on the capability of the sensor. For example, in an embodiment in which the sensor is a camera, the sensor capability information 101 may include a resolution of the camera, a focal length, aperture attributes, a field of view, shutter speed attributes, filter attributes, a quantity of maximum feature points detectable by the camera, a range of positions measurable by the camera, or minimum light requirements of the camera. Alternatively, in an embodiment in which the sensor is a global positioning system (“GPS”) sensor, the sensor capability information 101 may include error information intrinsic to the GPS sensor. The sensor adaptation preference 102 may denote information on preference of the user with respect to the sensor capability information. The sensed information 103 may denote information sensed by the sensor in relation to the real world 110.

The virtual world processing apparatus may include an adaptation real world to virtual world (RV) 120, virtual world information (VWI) 104, and an adaptation real world to virtual world/virtual world to real world (RV/VR) 130.

The adaptation RV 120 may convert the sensed information 103 sensed by the sensor in relation to the real world 110 into information applicable to the virtual world 140, based on the sensor capability information 101 and the sensor adaptation preference 102. Depending on embodiments, the adaptation RV 120 may be implemented by an RV engine.

The adaptation RV 120 according to example embodiments may convert the VWI 104 using the converted sensed information 103.

The VWI 104 denotes information about a virtual object of the virtual world 140.

The adaptation RV/VR 130 may generate virtual world effect metadata (VWEM) 107, which denotes metadata related to effects applied to the virtual world 140, by encoding the converted VWI 104. Depending on embodiments, the adaptation RV/VR 130 may generate the VWEM 107 based on virtual world capabilities (VWC) 105 and virtual world preferences (VWP) 106.

The VWC 105 denotes information about characteristics of the virtual world 140. The VWP 106 denotes information about a user preference with respect to the characteristics of the virtual world 140.

The adaptation RV/VR 130 may transmit the VWEM 107 to the virtual world 140. Here, the VWEM 107 may be applied to the virtual world 140 so that effects corresponding to the sensed information 103 may be implemented in the virtual world 140.

According to an aspect, an effect event generated in the virtual world 140 may be driven by a sensory device, that is, an actuator in the real world 110. For example, an explosion in the virtual world may result in vibration, bright lights, and loud noise, all driven by various actuators. In a second example, a car in the virtual world that is caused to temporarily veer off the road might result in vibration to a seat of the user by another actuator.

The virtual world 140 may encode sensory effect information, which denotes information on the effect event generated in the virtual world 140, thereby generating sensory effect metadata (SEM) 111. Depending on embodiments, the virtual world 140 may include the sensory media playing apparatus that plays contents including the sensory effect information.

The adaptation RV/VR 130 may generate sensory information 112 based on the SEM 111. The sensory information 112 denotes information on an effect event implemented by the sensory device of the real world 110.

The adaptation VR 150 may generate information on a sensory device command (SDCmd) 115 for controlling operation of the sensory device of the real world 110. Depending on embodiments, the adaptation VR 150 may generate the information on the SDCmd 115 based on information on sensory device capabilities (SDCap) 113 and information on user sensory preference (USP) 114.

The SDCap 113 denotes information on capability of the sensory device. The USP 114 denotes information on preference of the user with respect to an effect implemented by the sensory device.

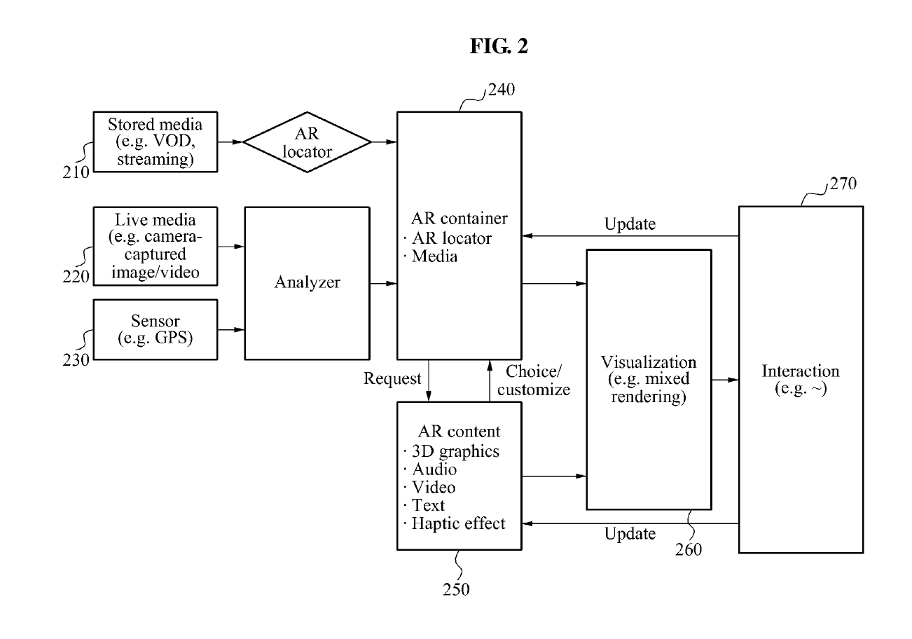

FIG. 2 illustrates an augmented reality (“AR”) system according to example embodiments.

Referring to FIG. 2, the AR system may obtain an image expressing the real world using a media storage device 210 or a real time media obtaining device 220. Additionally, the AR system may obtain sensor information expressing the real world, using various sensors 230. Sensor 230 may include a global positioning system (GPS) sensor or other location detection system, a thermometer or heat sensor, a motion sensor, a speed sensor, and the like.

An augmented reality (“AR”) camera according to example embodiments may include the real time media obtaining device 220 and the various sensors 230. The AR camera may obtain an image expressing the real world or the sensor information for mixing of real world information and a virtual object.

An AR container 240 refers to a device including not only the real world information but also information on a mixing method between the real world and the virtual object. For example, the AR container 240 may include information about a virtual object to be mixed, a point of time to mix the virtual object, and the real world information to be mixed with the virtual object.

The AR container 240 may request an AR content 250 for virtual object information based on the information on the mixing method between the real world and the virtual object. Here, the AR content 250 may refer to a device including the virtual object information.

The AR content 250 may return the virtual object information corresponding to the request of the AR container 240. The virtual object information may be expressed based on at least one of 3-dimensional (3D) graphic, audio, video, and text indicating the virtual object. Furthermore, the virtual object information may include interaction between a plurality of virtual objects.

A visualizing unit 260 may visualize the real world information included in the AR container 240 and the virtual object information included in the AR content 250 simultaneously. In this case, an interaction unit 270 may provide an interface enabling a user to interact with the virtual object through the visualized information. In addition, the interaction unit 270 may update the virtual object or update the mixing method between the real world and the virtual object, through the interaction between the user and the virtual object.

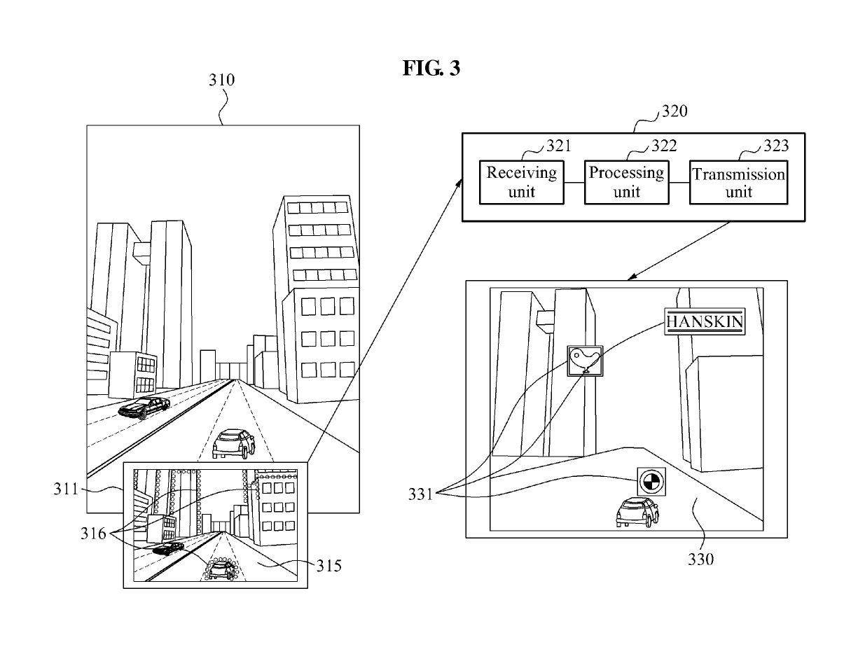

Hereinafter, a configuration of a virtual world processing apparatus according to example embodiments will be described in detail with reference to FIG. 3.

FIG. 3 illustrates a configuration of a virtual world processing apparatus 320 according to example embodiments.

Referring to FIG. 3, the virtual world processing apparatus 320 may include, for example, a receiving unit 321, a processing unit 322, and a transmission unit 323.

The receiving unit 321 may receive sensed information related to a taken image 315 and sensor capability information related to the image sensor 311. The sensed information may include location information, for example. The sensor capability information may include error information intrinsic to the GPS sensor providing the location information. The image sensor 311 may take a still image or a video image or both. For example, the image sensor 311 may include at least one of a photo taking sensor and a video sensor.

The processing unit 322 may generate control information for controlling an object of a virtual world, based on the sensed information and the sensor capability information. For example, the processing unit 332 may generate the control information when a value related to particular elements included in the sensed information is within an allowable range of the sensor capability information.

The transmission unit 323 may transmit the control information to the virtual world.

The operation of the virtual world may be controlled based on the control information.

For example, presuming that the image sensor 311 is an AR camera, the image sensor 311 may obtain the taken image 315 by photographing the real world 310. The image sensor 311 may extract a plurality of feature points 316 included in the taken image 315 by analyzing the taken image 315.

The feature points may be extracted mainly from interfaces of the taken image 315 and expressed by a 3D coordinate.

Depending on circumstances, the image sensor 311 may extract the feature points 316 related to an interface of a closest object or a largest object among the interfaces included in the taken image 315.

The image sensor 311 may transmit the sensed information including the extracted feature points 316 to the virtual world processing apparatus 320.

The virtual world processing apparatus 320 may extract the feature points 316 from the sensed information transmitted from the image sensor 311 and generate the control information including the extracted feature points or based on the extracted feature points.

Therefore, the virtual world processing apparatus 320 may generate the control signal for a virtual scene 330 corresponding to the real world 310, using only a small quantity of information, for example the feature points 316.

In this case, the virtual world may control the virtual object based on the plurality of feature points 316 included in the control information.

In further detail, the virtual world may express the virtual scene 330 corresponding to the real world 310 based on the plurality of feature points. In this case, the virtual scene 330 may be expressed as a 3D space. The virtual world may express a plane for the virtual scene 330 based on the feature points 316.

In addition, the virtual world may express the virtual scene 330 corresponding to the real world 310 and virtual objects 331 simultaneously.

According to the example embodiments, the sensed information and the sensor capability information received from the image sensor 311 may correspond to SI 103 and SC 101 of FIG. 1, respectively.

For example, the sensed information received from the image sensor 311 may be defined by Table 1.

TABLE 1
Sensed Information (SI, 103)

Camera sensor type
AR Camera type

Here, the AR camera type may basically include a camera sensor type. The camera sensor type may include elements such as resource elements, camera location elements, and camera orientation elements, and attributes such as focal length attributes, aperture attributes, shutter speed attributes, and filter attributes.

The resource elements may include a link to an image taken by the image sensor. The camera location element may include information related to a location of the image sensor measured by a global positioning system (GPS) sensor. The camera orientation element may include information related to an orientation of the image sensor.

The focal length attributes may include information related to a focal length of the image sensor. The aperture attributes may include information related to an aperture of the image sensor. The shutter speed attributes may include information related to a shutter speed of the image sensor. The filter attributes may include information related to filter signal processing of the image sensor. Here, the filter type may include an ultraviolet (UV) filter, a polarizing light filter, a neutral density (ND) filter, a diffusion filter, a star filter, and the like.

The AR camera type may further include a feature element and a camera position element.

The feature element may include a feature point related to interfaces in the taken image. The camera position element may include information related to a position of the image sensor, measured by a position sensor different from the GPS sensor.

As described above, the feature point may be generated mainly at the interfaces in the taken image taken by the image sensor. The feature point may be used to express the virtual object in an AR environment. More specifically, the feature element including at least one feature point may be used as an element expressing a plane by a scene descriptor. The operation of the scene descriptor will be explained in detail hereinafter.

The camera position element may be used to measure the position of the image sensor in an indoor space or a tunnel in which positioning by the GPS sensor is difficult.

The sensor capability information received from the image sensor 311 may be defined as in Table 2.

TABLE 2
Sensor Capability (SC, 101)

Camera sensor capability type
AR Camera capability type

Here, an AR camera capability type may basically include a camera sensor capability type. The camera sensor capability type may include a supported resolution list element, a focal length range element, an aperture range element, and a shutter speed range element.

The supported resolution list element includes a list of resolutions supported by the image sensor. The focal length range element includes a range of a focal length supported by the image sensor. An aperture range element includes a range of an aperture supported by the image sensor. The shutter speed range element includes a range of a shutter speed supported by the image sensor.

The AR camera capability type may further include a maximum feature point element and a camera position range element.

Here, the maximum feature point element may include a number of maximum feature points detectable by the image sensor. The camera position range element may include a range of positions measurable by the position sensor.

Table 3 shows extensible markup language (XML) syntax with respect to the camera sensor type according to the example embodiments.

TABLE 3
<!-- ################################################ -->
<!-- Camera Sensor Type-->
<!-- ################################################ -->
<complexType name=“CameraSensorType”>
<complexContent>
<extension base=“iidl:SensedInfoBaseType”>
<sequence>
<element name=“Resource” type=“anyURI”/>
<element name=“CameraOrientation” type=“siv:OrientationSensorType”
minOccurs=“0”/>
<element name=“CameraLocation” type=“siv:GlobalPositionSensorType”
minOccurs=“0”/>
</sequence>
<attribute name=“focalLength” type=“float” use=“optional”/>
<attribute name=“aperture” type=“float” use=“optional”/>
<attribute name=“shutterSpeed” type=“float” use=“optional”/>
<attribute name=“filter” type=“mpeg7:termReferenceType”
use=“optional/”>
</extension>
</complexContent>
</complexType>

Table 4 shows semantics with respect to the camera sensor type according to the example embodiments.

TABLE 4
Semantics of the CameraSensorType:

| Name | Definition |
|---|---|
| CameraSensorType | Tool for describing sensed information with respect to a |
| | camera sensor. |
| Resource | Describes the element that contains a link to image or video |
| | files. |
| CameraLocation | Describes the location of a camera using the structure defined |
| | by GlobalPositionSensorType. |
| CameraOrientation | Describes the orientation of a camera using the structure |
| | defined by OrientationSensorType. |
| focalLength | Describes the distance between the lens and the image |
| | sensor when the subject is in focus, in terms of millimeters (mm). |
| aperture | Describes the diameter of the lens opening. It is expressed as |
| | F-stop, e.g. F2.8. It may also be expressed as f-number |
| | notation such as f/2.8. |
| shutterSpeed | Describes the time that the shutter remains open when taking |
| | a photograph in terms of seconds (sec). |
| filter | Describes kinds of camera filters as a reference to a |
| | classification scheme term that shall be using the |
| | mpeg7:termReferenceType defined in 7.6 of ISO/IEC 15938- |
| | 5:2003. The CS that may be used for this purpose is the |
| | CameraFilterTypeCS defined in A.x.x. |

Table 5 shows XML syntax with respect to the camera sensor capability type according to the example embodiments.

TABLE 5
<!-- ################################################ -->
<!-- Camera Sensor capability type-->
<!-- ################################################ -->
<complexType name=“CameraSensorCapabilityType”>
<complexContent>
<extension base=“cidl:SensorCapabilityBaseType”>
<sequence>
<element name=“SupportedResolutions” type=“scdv:ResolutionListType”
minOccurs=“0”/>
<element name=“FocalLengthRange” type=“scdv:ValueRangeType”
minOccurs=“0”/>
<element name=“ApertureRange” type=“scdv:ValueRangeType”
minOccurs=“0”/>
<element name=“ShutterSpeedRange” type=“scdv:ValueRangeType”
minOccurs=“0”/>
</sequence>
</extension>
</complexContent>
</complexType>
<complexType name=“ResolutionListType”>
<sequence>
<element name=“Resolution” type=“scdv:ResolutionType”
maxOccurs=“unbounded”/>
</sequence>
</complexType>
<complexType name=“ResolutionType”>
<sequence>
<element name=“Width” type=“nonNegativeInteger”/>
<element name=“Height” type=“nonNegativeInteger”/>
</sequence>
</complexType>
<complexType name=“ValueRangeType”>
<sequence>
<element name=“MaxValue” type=“float”/>
<element name=“MinValue” type=“float”/>
</sequence>
</complexType>

Table 6 shows semantics with respect to the camera sensor capability type according to the example embodiments.

TABLE 6
Semantics of the CameraSensorCapabilityType:

| Name | Definition |
|---|---|
| CameraSensorCapabilityType | Tool for describing a camera sensor capability. |
| SupportedResolutions | Describes a list of resolution that the camera can support. |
| ResolutionListType | Describes a type of the resolution list which is composed of |
| | ResolutionType element. |
| ResolutionType | Describes a type of resolution which is composed of Width |
| | element and Height element. |
| Width | Describes a width of resolution that the camera can perceive. |
| Height | Describes a height of resolution that the camera can perceive |
| FocalLengthRange | Describes the range of the focal length that the camera sensor |
| | can perceive in terms of ValueRangeType. Its default unit is |
| | millimeters (mm). |
| | NOTE The minValue and the maxValue in the |
| | SensorCapabilityBaseType are not used for this sensor. |
| ValueRangeType | Defines the range of the value that the sensor can perceive. |
| MaxValue | Describes the maximum value that the sensor can perceive. |
| MinValue | Describes the minimum value that the sensor can perceive. |
| ApertureRange | Describes the range of the aperture that the camera sensor |
| | can perceive in terms of valueRangeType. |
| | NOTE The minValue and the maxValue in the |
| | SensorCapabilityBaseType are not used for this sensor. |
| ShutterSpeedRange | Describes the range of the shutter speed that the camera |
| | sensor can perceive in terms of valueRangeType. Its default |
| | unit is seconds (sec). |
| | NOTE The minValue and the maxValue in the |
| | SensorCapabilityBaseType are not used for this sensor. |

Table 7 shows XML syntax with respect to the AR camera type according to the example embodiments.

TABLE 7

<!-- ################################################ -->
<!-- AR Camera Type-->
<!-- ################################################ -->
<complexType name=“ARCameraType”>
<complexContent>
<extension base=“siv:CameraSensorType”>
<sequence>
<element name=“Feature” type=“siv:FeaturePointType”
minOccurs=“0”
maxOccurs=“unbounded”/>
<element name=“CameraPosition” type=“siv:PositionSensorType”
minOccurs=“0”/>
</sequence>
</extension>
</complexContent>
</complexType>
<complexType name=“FeaturePointType”>
<sequence>
<element name=“Position” type=“mpegvct:Float3DVectorType”/>
</sequence>
<attribute name=“featureID” type=“ID” use=“optional”/>
</complexType>

Table 8 shows semantics with respect to the AR camera type according to the example embodiments.

TABLE 8
Semantics of the ARCameraType:

| Name | Definition |
|---|---|
| ARCameraType | Tool for describing sensed information with respect |
| | to an AR camera. |
| Feature | Describes the feature detected by a camera using the |
| | structure defined by FeaturePointType. |
| FeaturePointType | Tool for describing Feature commands for each |
| | feature point. |
| Position | Describes the 3D position of each of the feature points. |
| featureID | To be used to identify each feature. |
| CameraPosition | Describes the location of a camera using the |
| | structure defined by PositionSensorType. |

Table 9 shows XML syntax with respect to the AR camera capability type according to the example embodiments.

TABLE 9

<!-- ################################################ -->
<!-- AR Camera capability type-->
<!-- ################################################ -->
<complexType name=“ARCameraCapabilityType”>
<complexContent>
<extension base=“siv:CameraSensorCapabilityType”>
<sequence>
<element name=“MaxFeaturePoint” type=“nonNegativeInteger”
minOccurs=“0”/>
<element name=“CameraPositionRange” type=“scdv:RangeType”
minOccurs=“0”/>
</sequence>
</extension>
</complexContent>
</complexType>

Table 10 shows semantics with respect to the AR camera capability type according to the example embodiments.

TABLE 10
Semantics of the ARCameraCapabilityType:

| Name | Definition |
|---|---|
| ARCameraCapabilityType | Tool for describing an AR camera capability. |
| MaxFeaturePoint | Describes the maximum number of feature |
| | points that the camera can detect. |
| CameraPositionRange | Describes the range that the position sensor |
| | can perceive in terms of RangeType in its |
| | global coordinate system. |
| | NOTE The minValue and the maxValue in |
| | the SensorCapabilityBaseType are not used |
| | for this sensor. |

Table 11 shows XML syntax with respect to the scene descriptor type according to the example embodiments.

TABLE 11
<!-- ########################################################### -->
<!-- Scene Descriptor Type-->
<!-- ########################################################### -->
<complexType name=″SceneDescriptorType″>
<sequence>
<element name=”image” type=”anyURI”/>
</sequence>
<complexType name=”plan”>
<sequence>
<element name=”ID” type=”int32”/>
<element name=″X″ type=″float″/>
<element name=″Y″ type=″float″/>
<element name=″Z″ type=″float″/>
<element name=”Scalar” type=”float”/>
</sequence>
</complexType>
<complexType name=”feature”>
<sequence>
<element name=”ID” type=”int32”/>
<element name=”X” type=”float”/>
<element name=”Y” type=”float”/>
<element name=”N” type=”float”/>
</sequence>
<complexType>
</complexType>

Here, image elements included in the scene descriptor type may include a plurality of pixels. The plurality of pixels may describe an identifier (ID) of a plan or an ID of a feature.

Here, the plan may include Xₚₗₐₙ, Yₚₗₐₙ, Zₚₗₐₙ, and Scalar. Referring to Equation 1, the scene descriptor may express a plane using a plane equation including Xₚₗₐₙ, Yₚₗₐₙ, and Zₚₗₐₙ.

(Xₚₗₐₙ)x+(Yₚₗₐₙ)y+(Zₚₗₐₙ)z+(Scalar)=0 [Equation 1]

The feature may be a type corresponding to the feature element included in the sensed information. The feature may include X_{feature}, Y_{feature}, and Z_{feature}. Here, the feature may express a 3D point (X_{feature}, Y_{feature}, Z_{feature}). The scene descriptor may express a plane using the 3D point located at (X_{feature}, Y_{feature}, Z_{feature}).

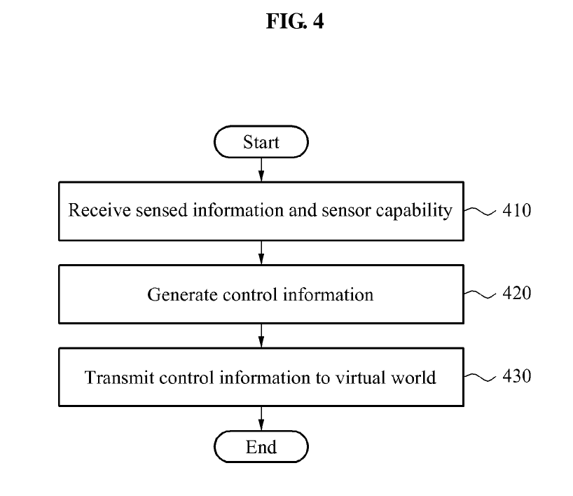

FIG. 4 illustrates a virtual world processing method according to example embodiments.

Referring to FIG. 4, in operation 410, the virtual world processing method may receive sensed information related to a taken image and sensor capability information related to capability of an image sensor, from the image sensor.

In operation 420, the virtual world processing method may generate control information for controlling an object of a virtual world based on the sensed information and the sensor capability information.

In operation 430, the virtual world processing method may transmit the control information to the virtual world.

Here, the operation of the virtual world may be controlled based on the control information. Since technical features described with reference to FIGS. 1 to 3 are applicable to respective operations of FIG. 4, a further detailed description will be omitted.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts.

Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. Any one or more of the software modules described herein may be executed by a controller such as a dedicated processor unique to that unit or by a processor common to one or more of the modules. The described methods may be executed on a general purpose computer or processor or may be executed on a particular machine such as the apparatuses described herein.

Although example embodiments have been shown and described, it would be appreciated by those skilled in the art that changes may be made in these example embodiments without departing from the principles and spirit of the disclosure, the scope of which is defined in the claims and their equivalents.

What is claimed is:

1. A virtual world processing apparatus comprising:
a receiving unit to receive, from an image sensor, sensed information related to a taken image and sensor capability information related to a capability of the image sensor;
a processing unit to generate control information for controlling an object of a virtual world based on the sensed information and the sensor capability information; and
a transmission unit to transmit the control information to the virtual world.

2. The virtual world processing apparatus of claim 1, wherein the image sensor comprises at least one of a photo taking sensor and a video taking sensor.

3. The virtual world processing apparatus of claim 1, wherein the sensed information comprises:
a resource element including a link to the taken image;
a camera location element including information related to a position of the image sensor measured by a global positioning system (GPS) sensor; and
a camera orientation element including information related to an orientation of the image sensor.

4. The virtual world processing apparatus of claim 1, wherein the sensed information comprises:
focal length attributes including information related to a focal length of the image sensor;
aperture attributes including information related to an aperture of the image sensor;
shutter speed attributes including information related to a shutter speed of the image sensor; and
filter attributes including information related to filter signal processing of the image sensor.

5. The virtual world processing apparatus of claim 3, wherein the sensed information further comprises:
a feature element including a feature point related to an interface in the taken image; and
a camera position element including information related to a position of the image sensor measured by a position sensor different from the GPS sensor.

6. The virtual world processing apparatus of claim 1, wherein the sensor capability information comprises:
a supported resolution list element including a list of resolutions supported by the image sensor;
a focal length range element including a range of a focal length supported by the image sensor;
an aperture range element including a range of an aperture supported by the image sensor; and
a shutter speed range element including a range of a shutter speed supported by the image sensor.

7. The virtual world processing apparatus of claim 6, wherein the sensor capability information further comprises:
a maximum feature point element including a number of maximum feature points detectable by the image sensor; and
a camera position range element including a range of positions measurable by the position sensor.

8. The virtual world processing apparatus of claim 1, wherein
the processing unit extracts at least one feature point included in the taken image from the sensed information,
the transmission unit transmits the at least one feature point to the virtual world, and
the virtual world expresses at least one plane included in the virtual world based on the at least one feature point.

9. A virtual world processing method comprising:
receiving, from an image sensor, sensed information related to a taken image and sensor capability information related to a capability of the image sensor;
generating control information for controlling an object of a virtual world, based on the sensed information and the sensor capability information; and
transmitting the control information to the virtual world.

10. A non-transitory computer readable recording medium storing a program to cause a computer to implement the method of claim 9.

11. The virtual world processing method of claim 9, wherein the receiving of the sensed information related to the taken image comprises receiving at least one of a still image taken by a photo taking sensor and a video image taken by a video taking sensor.

12. The virtual world processing method of claim 9, wherein the sensed information comprises:
a resource element including a link to the taken image;
a camera location element including information related to a position of the image sensor measured by a global positioning system (GPS) sensor; and
a camera orientation element including information related to an orientation of the image sensor.

13. The virtual world processing method of claim 9, wherein the sensed information comprises:
focal length attributes including information related to a focal length of the image sensor;
aperture attributes including information related to an aperture of the image sensor;
shutter speed attributes including information related to a shutter speed of the image sensor; and
filter attributes including information related to filter signal processing of the image sensor.

14. The virtual world processing method of claim 12, wherein the sensed information further comprises:
a feature element including a feature point related to an interface in the taken image; and
a camera position element including information related to a position of the image sensor measured by a position sensor different from the GPS sensor.

15. The virtual world processing method of claim 1, wherein the sensor capability information comprises:
a supported resolution list element including a list of resolutions supported by the image sensor;
a focal length range element including a range of a focal length supported by the image sensor;
an aperture range element including a range of an aperture supported by the image sensor; and
a shutter speed range element including a range of a shutter speed supported by the image sensor.

16. The virtual world processing method of claim 15, wherein the sensor capability information further comprises:
a maximum feature point element including a number of maximum feature points detectable by the image sensor; and
a camera position range element including a range of positions measurable by the position sensor.

17. The virtual world processing method of claim 9, further comprising:
extracting at least one feature point included in the taken image from the sensed information;
transmitting the at least one feature point to the virtual world; and
expressing at least one plane included in the virtual world based on the at least one feature point.

18. A virtual world processing apparatus comprising:
a receiving unit to receive, from an augmented reality (“AR”) camera, sensed information related to an image obtained by the AR camera and sensor capability information related to a capability of the AR camera;
a processing unit to extract a plurality of features points from the image obtained by the AR camera and to generate control information for controlling an object of a virtual world based on the extracted feature points and the sensor capability information; and
a transmission unit to output the control information generated by the processing unit to the virtual world.

19. The virtual world processing apparatus of claim 18, wherein the virtual world controls the object of the virtual world using the plurality of features points included within the control information generated by the processing unit.

20. The virtual world processing apparatus of claim 19, wherein the virtual world controls the object of the virtual world by expressing at least one plane included in the virtual world based on the plurality of feature points.
